(19) United States
(12) Patent Application Publication
(10) Pub. No.: US 2012/0259957 A1
(43) Pub. Date: Oct. 11, 2012

(54) APPARATUS AND METHOD FOR PROVIDING CONTENT USING A NETWORK CONDITION-BASED ADAPTIVE DATA STREAMING SERVICE

(75) Inventors: Ji-Eun KEUM, Suwon-si (KR); Bo-Sun Jung, Seongnam-si (KR); Jae-Yeon Song, Seoul (KR)

(73) Assignee: Samsung Electronics Co., Ltd., Suwon-si (KR)

(21) Appl. No.: 13/441,478

(22) Filed: Apr. 6, 2012

(30) Foreign Application Priority Data
Apr. 6, 2011 (KR) 10-2011-0031750

(51) Int. Cl. G06F 15/16

(52) U.S. Cl. 709/219

(57) ABSTRACT

An apparatus and method provides content data on a personal terminal using an adaptive streaming service. A user terminal receives, from a media management server, a metadata file needed for receiving content data stored in a home media server or another terminal. Based on information recorded in the metadata file, the user terminal provides a content service including the content files by segmenting target content data to support an optimal bit rate based on at least one of its performance and network conditions.

### PRIORITY

This application claims priority under 35 U.S.C. §119(a) to Korean Patent Application Serial No. 10-2011-0031750, which was filed in the Korean Intellectual Property Office on Apr. 6, 2011, the entire disclosure of which is hereby incorporated by reference.

### BACKGROUND OF THE INVENTION

1. Field of the Invention

The present invention relates generally to an apparatus and method for providing content, and more particularly, to an apparatus and method for providing content data on a personal terminal using an adaptive streaming service.

2. Description of the Related Art

Generally, content is distributed via servers managed by content providers. Therefore, in order to receive specific content, a user first accesses a content provider server, in which content is stored, and then receives the specific content using a personal terminal, e.g., a mobile phone.

Adaptive streaming technology, which his currently under development, proposes to adaptively change a bit rate for content services based on available bandwidth in a network and/or performance (or capabilities) of personal terminals.

A typical example of an adaptive streaming technology is a Hypertext Transfer Protocol (HTTP)-based adaptive streaming technology, which generates content files by segmenting content data into small units, selects all or some of the segmented content files depending on the service environment of personal terminals, and provides the selected content files to the personal terminals. As a result, users of the personal terminals can receive content services without delay and/or interruption despite changes in their service environments.

However, because adaptive streaming technology is applied to content provider servers, adaptive streaming technology does not improve a user's streaming of content stored in a home server.

### SUMMARY OF THE INVENTION

The present invention is designed to address at least the above-described problems occurring in the prior art, and to provide at least the advantages described below.

Accordingly, an aspect of the present invention is to provide an apparatus and method for a terminal to provide or receive content data stored in a home media server or other terminal using a network condition-based adaptive data streaming service.

Another aspect of the present invention is to provide an apparatus and method for a remote terminal to provide content stored in a home media server or other terminal using a network condition-based adaptive data streaming service.

Another aspect of the present invention is to provide an apparatus and method for an external terminal to play user content stored in a home media server or user content data created by other terminal, using adaptive streaming technology.

In accordance with an aspect of the present invention, a method for providing content stored in a home media server or other mobile terminal using a network condition-based adaptive data streaming service in a mobile terminal is provided. The method includes requesting, by the mobile terminal, the home media server or the other mobile terminal to provide target content data stored therein; receiving a metadata file from a media management server that the home media server or the other mobile terminal can access; and receiving content files that are generated by segmenting the target content data to support an optimal data streaming service in current network conditions, from one of the media management server, the home media server, and the other mobile terminal, based on information included in the metadata file.

In accordance with another aspect of the present invention, an apparatus for providing content stored in a home media server or other mobile terminal using a network condition-based adaptive data streaming service in a mobile terminal is provided. The apparatus includes a communication unit that requests the home media server or the other mobile terminal to provide target content data stored therein, receives a metadata file from a media management server that the home media server or the other mobile terminal can access, and receives content files from one of the media management server, the home media server, and the other mobile terminal; a content player that plays the content files received via the communication unit; and a controller that controls the communication unit to request the home media server or the other mobile terminal to provide the target content data, controls the communication unit to receive the content files from one of the media management server, the home media server, and the other mobile terminal, based on information included in the metadata file, and controls the content player to play the content files. The content files are generated by segmenting the target content data to support an optimal data streaming service in current network conditions.

In accordance with another aspect of the present invention, a method for providing content data to another mobile terminal using a network condition-based adaptive data streaming service in a home media server or a mobile terminal accessible to a media management server is provided. The method includes receiving, from the another mobile terminal, a request to provide target content data stored in the home media server or the mobile terminal; and requesting the media management server to provide a metadata file corresponding to the target content data to the another mobile terminal; and providing the target content data, information about target content, and access information for the another mobile terminal to the media management server.

In accordance with another aspect of the present invention, an apparatus for providing content data to another mobile terminal using a network condition-based adaptive data streaming service in a home media server or a mobile terminal accessible to a media management server is provided. The apparatus includes a memory for storing content data; a communication unit that receives a request to provide target content data from the content data stored in the memory from the another mobile terminal, requests the media management server to provide a metadata file corresponding to the target content data to the another mobile terminal; and a controller that controls the communication unit to request the media management server to provide the metadata file to the another mobile terminal, and to provide the target content data, information about target content, and access information for the another mobile terminal to the media management server.

In accordance with another aspect of the present invention, a method is provided for supporting a content service for a mobile terminal based on a network condition in a media management server. The method includes receiving a request to provide a metadata file to the mobile terminal from a home media server or other mobile terminal that can access the media management server; generating the metadata file corresponding to target content data requested by the mobile terminal in content data stored in the home media server or the other mobile terminal, based on the target content data, information about the target content, and access information for the mobile terminal received from the home media server or the other mobile terminal; and transmitting the generated metadata file to the mobile terminal.

In accordance with another aspect of the present invention, an apparatus is provided for supporting a content service for a mobile terminal based on a network condition in a media management server. The apparatus includes a communication unit that receives a request to provide a metadata file to the mobile terminal from a home media server or other mobile terminal that can access the media management server, and transmits a metadata file to the mobile terminal; and a metadata file generator that generates the metadata file corresponding to target content data requested by the mobile terminal from content data stored in the home media server or the other mobile terminal, based on the target content data, information about the target content, and access information for the mobile terminal received from the home media server or the other mobile terminal.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a content service system for providing target content according to an embodiment of the present invention;

FIG. 2 is block diagram illustrating a terminal for playing content according to an embodiment of the present invention;

FIG. 3 is block diagram illustrating a home media server or a terminal that supports content playback in an external terminal according to an embodiment of the present invention;

FIG. 4 is block diagram illustrating a media management server that supports content playback in an external terminal according to an embodiment of the present invention;

FIG. 5 is a signal flow diagram illustrating a signal processing procedure performed in a content service system according to an embodiment of the present invention; and

FIG. 6 is a signal flow diagram illustrating a signal processing procedure performed in a content service system according to another embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention, and it should be apparent to those skilled in the art that various changes and modifications of the embodiments described herein can be made without departing from the scope and spirit of the present invention. In addition, descriptions of well-known functions and constructions are omitted for clarity and conciseness.

For convenience of description, the same terms as those defined in 3^{rd} Generation Partnership Project (3GPP), Moving Picture Experts Group (MPEG), Open IPTV Forum (OIPF), and Universal Plug and Play (UPnP) will be used herein. However, the terms used herein are not intended to limit the scope of the invention, and the same or slightly modified embodiments of the present invention may also be applied to any systems having the similar technical backgrounds.

The terms to be used herein will be defined in brief as follows:

Content: digital information (content data) provided through a wired/wireless communication network. For example, various programs (e.g., game software) and information content (e.g., movies and music), which are provided through the wired/wireless communication network, may all be considered to be content.

Adaptive Data Streaming Service: a service that adaptively determines and/or adjusts a bit rate based on performance of personal terminals and/or network conditions, for data transmission.

Metadata File: a file including information provided to define or describe digital information (content data) corresponding to the target content. The metadata file may also be referred to as Manifest or Media Presentation Description (MPD). For example, the metadata file includes information about the temporal and spatial location where the target content data exists. A typical example of the spatial location may be Uniform Resource Locator (URL) information indicating the location where the target content data is stored.

Content File: a file including content data, which is generated by segmenting the content data into optimal sized segments for each bit rate, for an adaptive data streaming service.

Terminal Access Information: information that a certain entity should know to access a specific external terminal over the network. For example, the terminal access information may include an Internet Protocol (IP) address assigned to a specific terminal and security information for accessing the specific terminal.

Target Content: content requested by a terminal over a network, which is stored in a home media server and/or other terminal(s).

Information about Target Content: information used to generate a metadata file corresponding to the target content, or additional information for obtaining the target content. For example, Information about Target Content may include information about resolution, Digital Rights Management (DRM), title, content provider, etc., of the target content.

Segment: a temporal section of media data, to which reference can be made using a unique URL in a type (e.g., Transport Stream (TS), MPEG-4 Part 14 (MP4), etc.) of a specific system layer. The term “media data” as used herein may also be referred to as “representation”. It should be noted that in the following description, both terms can be used interchangeably.

In accordance with the various embodiments of the present invention described below, a terminal connected to a home media server or other terminal over a network may play content stored in the home media server or the other terminal.

More specifically, in accordance with the various embodiments described below, although a metadata file corresponding to target content is generated by a fixed device (e.g., media management server), a device for providing content files for the target content to a terminal may be different (e.g., media management server, home media server, or other terminal).

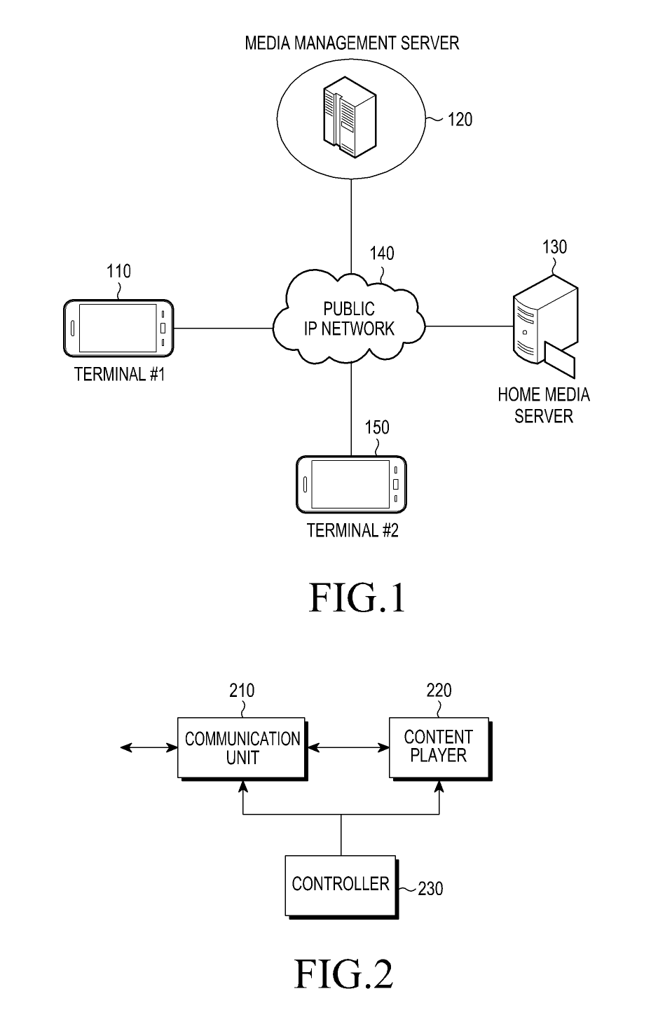

FIG. 1 illustrates a content service system for providing target content according to an embodiment of the present invention.

Referring to FIG. 1, the content service system includes a user terminal 110 and a target terminal 150 connected to each other over a network 140, a home media server 130, and a media management server 120. The user terminal 110 provides target content based on received target content data, and the target terminal 150 stores content data. The user terminal 110 and the target terminal 150 may be wired terminals or wireless terminals.

The user terminal 110 accesses the target terminal 150 and the home media server 130 over the network 140. The target terminal 150 accesses the user terminal 110 and the media management server 120 over the network 140. However, the target terminal 150 and the home media server 130 do not necessarily need to access each other over the network 140.

Further, although all of the components in FIG. 1 are connected over the network 140, the components do not need to be connected over the same network.

The user terminal 110 supports an adaptive streaming service, and obtains information recorded in a metadata file received from the media management server 120. Based on the obtained information, the user terminal 110 identifies content pieces (e.g., content files) having a bit rate appropriate for current network conditions, and plays the content files.

Specifically, the user terminal 110 requests the home media server 130 or the target terminal 150 to provide target content data. In response, the user terminal 110 receives a metadata file from the media management server 120. Accordingly, the media management server 120 is accessible by the home media server 130 or the target terminal 150.

The user terminal 110 then receives the desired target content data based on information recorded in the received metadata file. That is, the user terminal 110 receives the target content data at a bit rate appropriate for the current network conditions based on the received metadata file.

For example, the user terminal 110 receives content files generated to support an optimal data streaming service from any one of the media management server 120, the home media server 130, and the target terminal 150. As described above, the content files may be prepared in advance or generated in real time to support an optimal data streaming service, based on the current network conditions.

The content files may be generated by segmenting target content data into data segments of a size supporting a bit rate for an optimal data streaming service.

For example, target content data, information about target content, and access information for the user terminal 110 is provided in advance to the media management server 120 by the home media server 130 or the target terminal 150, in order for the user terminal 110 to receive content files from the media management server 120.

The user terminal 110 identifies a location at which desired content files are stored, from the information in the received metadata file. The user terminal 110 then sets up an HTTP session based on the identified location to access the desired content files stored in the media management server 120, the home media server 130 or the target terminal 150. For example, the identified location may correspond to information about a URL where the desired content files are stored.

Thereafter, the user terminal 110 receives desired content files from a specific storage area in any one of the media management server 120, the home media server 130, and the target terminal 150 based on the HTTP session.

The home media server 130 stores various content data and provides desired content services. Basically, the home media server 130 can share data with other devices over the network 140.

The target terminal 150, shares content with a user of the user terminal 110, and can also share data with other devices over the network 140.

The user terminal 110 and the home media server 130 or the target terminal 150 may perform a separate authentication procedure to share content data, which can increase the security of personal data.

The home media server 130 includes a memory for storing content data for content services.

Similar to the target terminal 150, the home media server 130 provides content data to the user terminal 110 using a network condition-based adaptive data streaming service. For the adaptive data streaming service, the home media server 130 may also consider the performance of the user terminal 110 in addition to network conditions.

Upon receiving a request to provide target content data from the user terminal 110, the home media server 130 requests the media management server 120 to provide a metadata file to the user terminal 110. The metadata file includes configuration information that the user terminal 110 will use to receive the target content data. For example, the configuration information may include target content data, information about target content, and access information for a user terminal.

However, if the home media server 130 can directly transmit the target content data to the user terminal 110, the target content data does not need to be provided to the media management server 120. Instead, the home media server 130 provides information about target content and access information for a user terminal to the media management server 120 as configuration information for requesting to provide a metadata file.

In this case, the home media server 130 generates content files it will transmit at various different bit rates. In other words, the home media server 130 generates content files corresponding to each of the bit rates used to provide an optimal data streaming service, for each predictable network condition. The content files are then generated by segmenting target content data into segments of a size supporting the appropriate bit rate.

Using the information recorded in the metadata file, the media management server 120 transmits, to the user terminal 110, content files generated to correspond to the bit rate desired by the user terminal 110.

The home media server 130 sets up an HTTP session to the user terminal 110. However, if the content files desired by the user terminal 110 are not located in the home media server 130, the HTTP session is unnecessary. The home media server 130 then transmits the content files to the user terminal 110 on the HTTP session. The session being set up means that the content files to be transmitted are selected.

Upon request from the home media server 130 or the target terminal 150, the media management server 120 generates a metadata file and provides the metadata file to the user terminal 110. For example, to generate the metadata file, the media management server 120 may receive configuration information including information about target content and access information for the user terminal 110 from the home media server 130 or the target terminal 150.

The metadata file includes location information for accessing content files that are generated for each bit rate by the target content data. For example, the media management server 120 will record information about the location where content files are stored, in the metadata file for each bit rate, if it stores content files for each bit rate.

Upon receiving target content data from the home media server 130 or the target terminal 150, the media management server 120 generates content files by segmenting the target content data, for each bit rate to be supported. The segmentation is then made in a size appropriate to support a data streaming service for each expected network condition.

The media management server 120 transmits, to the user terminal 110, the content files generated based on the metadata file provided to the user terminal 110.

To transmit the content files, the media management server 120 sets up an HTTP session to the user terminal 110 in response to a request from the user terminal 110, and then transmits the content files desired by the user terminal 110 based on the HTTP session.

For example, the media management server 120 may belong to a service provider, or may be owned by a manufacturer.

The above-described configuration of FIG. 1 is an improvement over a conventional home media server or a conventional terminal installed in a home, which does not support a function of generating a metadata file. In addition, a conventional home media server or terminal does not support a signal processing procedure for requesting or receiving information about content for HTTP adaptive streaming.

FIG. 2 is block diagram illustrating a content playback device provided in a user terminal according to an embodiment of the present invention. Specifically, the content playback device is provided in the user terminal 110 to play content data stored in the home media server or the target terminal using a network condition-based adaptive data streaming service.

Referring to FIG. 2, the content playback device includes a communication unit 210, a content player 220, and a controller 230. The communication unit 210 requests the home media server 130 or the target terminal 150 to provide target content from the stored content, and in response to the request, receives a metadata file from the media management server 120. As described above, the media management server 120 is accessible by the home media server 130 or the target terminal 150 requested by the communication unit 210 to provide the target content data.

As described above, in order for the communication unit 210 to receive a metadata file from the media management server 120, configuration information is stored in the media management server 120. Therefore, it is assumed that the configuration information is provided in advance to the media management server 120 by the home media server 130 or the target terminal 150.

The communication unit 210 then receives desired content files from any one of the media management server 120, the home media server 130, and the target terminal 150 based on the information in the received metadata file. Accordingly, the received metadata file includes location information designating the content files recorded in any one of the media management server 120, the home media server 130, and the target terminal 150.

More specifically, the communication unit 210 identifies where content files are stored, from (or based on) the information recorded in the metadata file. Based on the identified location, the communication unit 210 selects one of the media management server 120, the home media server 130, and the target terminal 150, where the desired content files are recorded. The communication unit 210 sets up an HTTP session for accessing the content files recorded in the selected entity. The communication unit 210 then receives desired content files based on the HTTP session.

The content player 220 plays content files provided from the communication unit 210. That is, the content player 220 plays a target content service using the content files received by the communication unit 210.

The controller 230 controls the overall operation of providing the target content selected by the user. More specifically, the controller 230 commands the communication unit 210 to request the home media server 130 or the target terminal 150 to provide the target content data. Based on the information recorded in the metadata file received through the communication unit 210, the controller 230 selects desired content files and obtains information about the location where the selected content files are designated. The controller 230 controls the communication unit 210 to receive content files from the location where the selected content files are stored (which corresponds to the obtained location information), among the media management server 120, the home media server 130, and the target terminal 150. The content files are generated by segmenting target content data in a predetermined size, i.e., a size with which transmission at a bit rate to support an optimal data streaming service in the current network condition is possible.

Upon receiving the desired content files through the communication unit 210, the controller 230 controls the content player 220 to provide the user with the target content service using the received content files.

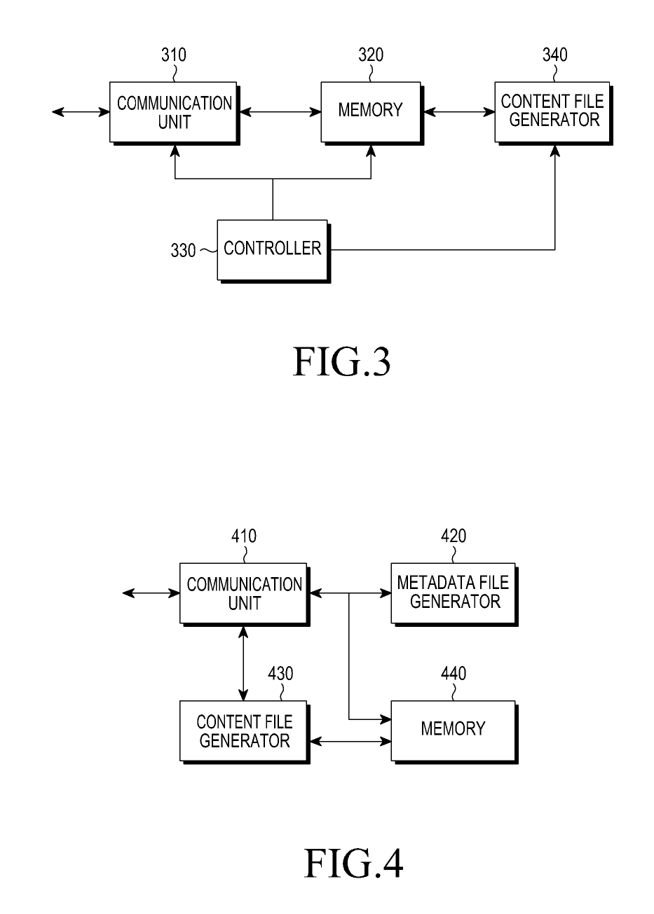

FIG. 3 is block diagram illustrating a content providing (or content delivery) device provided in a home media server or a target terminal according to an embodiment of the present invention. Specifically, the content providing device provides its stored content data to the user terminal 110, for a network condition-based adaptive data streaming service.

Referring to FIG. 3, the content providing device includes a communication unit 310, a memory 320, a controller 330, and a content file generator 340, which is used when the content providing device directly provides target content data to the user terminal 110. The memory 320 stores content data and provides the communication unit 310 with target content data from the stored content data, under control of the controller 330.

Additionally, the memory 320 may provide the content file generator 340 with target content data from the stored content data, under control of the controller 330. In this case, the memory 320 stores the content files generated by the content file generator 340 to support each of various bit rates. The memory 320 provides the stored content files to the communication unit 310 under control of the controller 330. The content files provided to the communication unit 310 are generated by segmenting target content data, and are generated to be appropriate to support an optimal bit rate when at least one of the performance of the user terminal 110 and current network conditions are taken into consideration.

The communication unit 310, under control of the controller 330, requests the media management server 120 to provide a metadata file to the user terminal 110. Accordingly, the communication unit 310 provides configuration information for generating a metadata file to the media management server 120, under control of the controller 330. The configuration information includes information about target content and access information for the user terminal 110. The configuration information may further include target content data provided from the memory 320 by the controller 330.

As another example, the communication unit 310 may transmit content files provided from the memory 320 to the user terminal 110, under control of the controller 330. Accordingly, the communication unit 310 sets up an HTTP session to the user terminal 110, e.g., based on information recorded in the metadata file provided to the user terminal 110 by the media management server 120.

The controller 330 controls the overall operation of providing the target content data to the user terminal 110. Specifically, upon receiving a request to provide target content data via the communication unit 310, the controller 330 controls the communication unit 310 to request the media management server 120 to provide a metadata file to the user terminal 110.

To request the media management server 120 to provide a metadata file to the user terminal 110, the controller 330 commands the communication unit 310 to provide target content data, information about target content, and access information for a user terminal, to the media management server 120.

Under control of the controller 330, the content file generator 340 generates content files to provide content data stored in the memory 320 at different bit rates, i.e., generates content files by segmenting the content data stored in the memory 320, according to a bit rate supportable in each of various network conditions.

The content file generator 340 provides the memory 320 with the content files it generated for each bit rate under control of the controller 330. Thereafter, the memory 320 stores and manages the content files for each bit rate.

FIG. 4 is block diagram illustrating a content service supporting device provided in a media management server according to an embodiment of the present invention.

Referring to FIG. 4, the content service supporting device includes a communication unit 410, a metadata file generator 420, a content file generator 430, and a memory 440. The content file generator 430 is not necessarily included, when the content service supporting device does not need to directly provide target content data to the user terminal 110.

The communication unit 410 receives a request to provide a metadata file from the home media server 130 or the target terminal 150. Upon receiving the request, the communication unit 410 transmits, to the user terminal 110, a metadata file generated by the metadata file generator 420 or a metadata file stored in the memory 440.

The communication unit 410 receives configuration information for generating a metadata file from the home media server 130 or the target terminal 150. The communication unit 410 provides the received configuration information to the metadata file generator 420. The configuration information includes information about target content and access information for the user terminal 110. The configuration information may further include target content data.

When the configuration information includes target content data, the communication unit 410 extracts the target content data from the configuration information and provides it to the content file generator 430.

Upon request from the user terminal 110, the communication unit 410 transmits, to the user terminal 110, content files generated by the content file generator 430 or content files generated in advance and stored in the memory 440. Accordingly, the communication unit 410 sets up an HTTP session to the user terminal 110, based on information in the metadata file provided to the user terminal 110.

Upon receiving a request to provide a metadata file via the communication unit 410, the metadata file generator 420 generates a metadata file requested by the user terminal 110 and corresponding to the target content data. The metadata file generator 420 receives configuration information via the communication unit 410 to generate a metadata file.

If the configuration information includes target content data, the metadata file generator 420 records, in the metadata file, information about a location where content files generated for each bit rate are stored. The content file generator 430 generates the content files for each bit rate by segmenting the target content data included in the configuration information.

The location information identifies a location where content files are stored, which are generated based on a desired bit rate, among the content files generated or to be generated based on the content data requested by the user terminal 110.

The content file generator 430 generates content files taking the current network condition into account, i.e., by segmenting the received content data in a size satisfying a bit rate required to support an optimal data streaming service in current network conditions. The content file generator 430 may additionally consider the performance of the user terminal 110, when it generates content files for each bit rate. The content file generator 430 may additionally generate media data in addition to the content files.

The content file generator 430 may generate content files in advance for each network condition, and then select and output previously generated content files appropriate for the current network conditions. In this case, the content file generator 430 may store, in the memory 440, the content files generated in advance for each network condition (e.g., for each bit rate), read content files corresponding to the current network condition among the stored content files, and output the read content files to the communication unit 410.

The memory 440 stores configuration information received via the communication unit 410, a metadata file generated by the metadata file generator 420, and content files generated by the content file generator 430. For example, the generated content files may be stored in different locations according to their media data. That is, the content files are stored separately according to the type of target content and the bit rate that was taken into consideration for their generation, and the location information (e.g., URL information) of the area where content files are stored should be managed separately.

The memory 440 stores characteristic information of the user terminal 110.

The memory 440 outputs the configuration information, metadata file, and content files stored therein to the communication unit 410, the metadata file generator 420, and the content file generator 430.

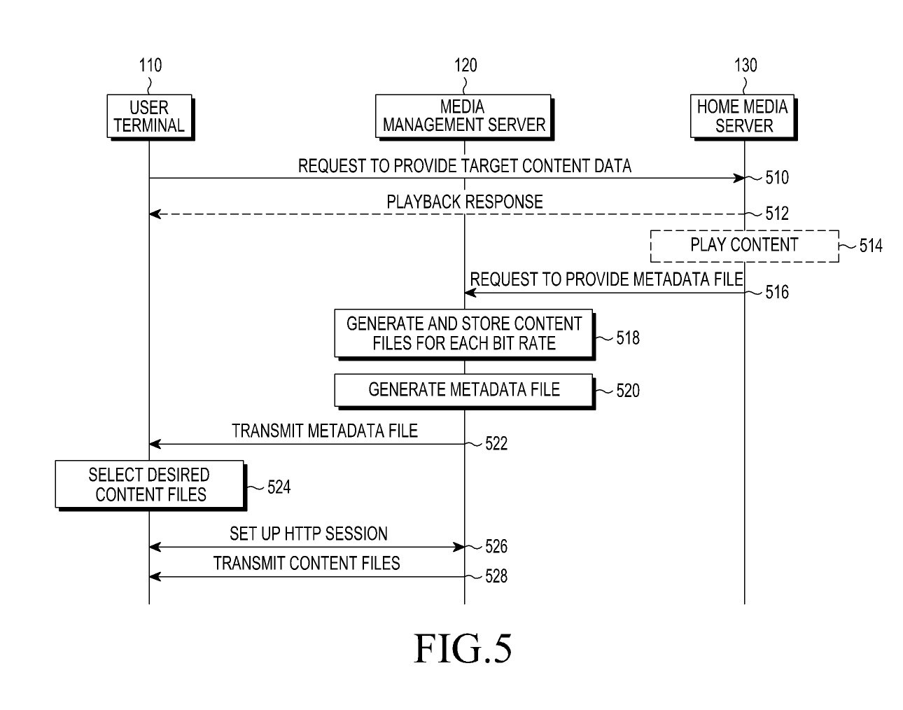

FIG. 5 is a signal flow diagram illustrating a signal processing procedure for playing content in a content service system according to an embodiment of the present invention. Specifically, a media management server 120 generates content files for each bit rate depending on the performance of a user terminal 110 and network conditions.

In FIG. 5, the user terminal 110 requests a home media server 130 to provide target content data. However, the user terminal 110 may instead request the target terminal 150 to provide target content data. Thereafter, almost the same signal processing procedure will be performed, with the home media server 130 merely replaced by the target terminal 150. That is, when the target terminal 150 replaces the home media server 130, two dotted steps 512 and 514 in FIG. 5 may be additionally performed.

Referring to FIG. 5, the user terminal 110 requests the home media server 130 to provide target content data in step 510. For example, requesting the home media server 130 to provide the target content data may be performed on a Remote Service session defined in Universal Plug and Play (UPnP). In addition, the user terminal 110 may send a playback request message to the home media server 130 using other known schemes for message transmission.

Upon receiving the request to provide target content data, the home media server 130 requests the media management server 120 to provide a metadata file in step 516. When requesting to provide a metadata file, the home media server 130 transmits configuration information for generating a metadata file, to the media management server 120. The configuration information includes access information for the user terminal 110, and security information used to access the user terminal 110. For example, the access information for the user terminal 110 may be an IP address assigned to the user terminal 110.

The home media server 130 may transmit target content data and information about target content to the media management server 120 together with or independently of the configuration information. The information about target content may be metadata information for target content. For example, the information about the target content may be information about resolution, DRM, title, content provider, etc. of the target content. The information about target content will be used by the media management server 120 to generate a metadata file.

Upon receiving the request to provide a metadata file, the media management server 120 generates content files for each bit rate using the target content data, and stores the content files generated for each bit rate, in step 518. Each bit rate is optimized to transmit target content data, based on at least one of the characteristics of the user terminal 110 and network conditions.

The operation of generating and storing content files does not need to be performed in the exact order illustrated in FIG. 5. That is, the media management server 120 may generate and store the content files at any time between steps 516 and 526.

In step 520, the media management server 120 generates a metadata file for use of target content. The metadata file may be generated based on the configuration information provided from the home media server 130. For example, the media management server 120 may generate a metadata file corresponding to the target content data based on the information about target content in addition to the access information for the user terminal 110 and the security information needed to access the user terminal 110, which are included in the configuration information. For example, the metadata file may be an MPD of a profile, which may be analyzed by the user terminal 110. In this case, the media management server 120 may generate the MPD in accordance with 3GPP TS 26.234.950, or may generate the MPD in the form defined in OIPF or MPEG.

The media management server 120 transmits the generated metadata file to the user terminal 110 in step 522.

Upon receiving the metadata file from the media management server 120 in step 522, the user terminal 110 selects optimal content files it will use, based on the information recorded in the received metadata file in step 524. For example, the user terminal 110 determines an optimal bit rate at which it will play target content, based on the current network conditions and its performance. The user terminal 110 may select content files corresponding to the determined bit rate.

In step 526, to receive the selected content files, the user terminal 110 sets up an HTTP session to the media management server 120 based on the information recorded in the received metadata file. For example, the user terminal 110 sets up an HTTP session to a URL corresponding to the location where the selected content files are present, within the media management server 120.

When the HTTP session is set up, in step 528, the media management server 120 transmits the content files selected by the user terminal 110 based on the HTTP session. The user terminal 110 provides a service such as receiving the content files transmitted from the media management server 120 and playing desired content using the received content files.

However, when the procedure of FIG. 5 is performed by the target terminal 150 rather than the home media server 130, the target terminal 150 may additionally perform steps 512 and 514. That is, upon receiving a request to provide target content data from the user terminal 110, in step 512, the target terminal 150 provides a playback response to the user terminal 110 in response to request. The target terminal 150 plays the target content requested by the user terminal 110 in step 514.

Alternatively, step 514 may be performed before the request to provide target content data is received from the user terminal 110, i.e., the content may be generated and played by the other terminal 150 before the request to provide target content data is received from the user terminal 110.

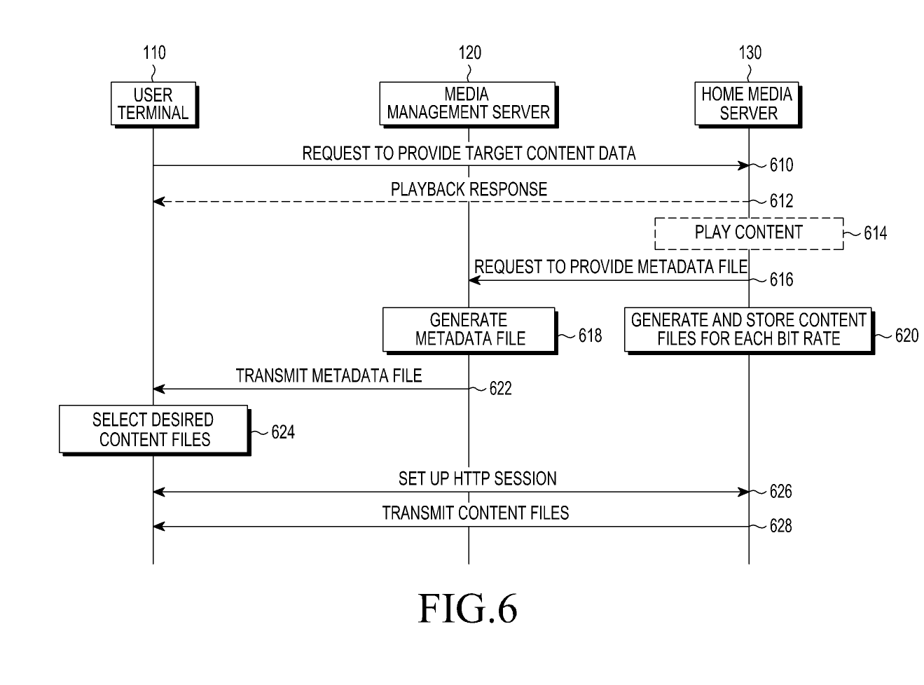

FIG. 6 is a signal flow diagram illustrating a signal processing procedure for playing content in a content service system according to an embodiment of the present invention. Specifically, a home media server 130 or a target terminal 150 generates content files for each bit rate depending on the performance of a user terminal 110 and network conditions.

Like FIG. 5, in FIG. 6, the user terminal 110 requests the home media server 130 to provide target content data. However, the user terminal 110 may also request the target terminal 150 to provide target content data, using basically the same signal processing procedure, with the home media server 130 merely replaced by the target terminal 150. When the target terminal 150 replaces the home media server 130, two dotted steps 612 and 614 in FIG. 6 may be additionally performed.

Referring to FIG. 6, the user terminal 110 requests the home media server 130 to provide target content data in step 610.

Upon receiving the request to provide target content data, the home media server 130 requests the media management server 120 to provide a metadata file in step 616.

In step 620, the home media server 130 generates content files for each bit rate using the target content data and stores the content files generated for each bit rate, wherein each bit rate is optimized to transmit the target content data, based on at least one of the characteristics of the user terminal 110 and the network condition.

The operation of generating and storing content files do not need to be performed in the exact order illustrated in FIG. 6. That is, the home media server 130 may generate and store the content files at any time between steps 610 and 626.

Upon receiving the request to provide a metadata file, in step 618, the media management server 120 generates a metadata file for use of target content, based on the configuration information provided from the home media server 130.

In step 622, the media management server 120 transmits the generated metadata file to the user terminal 110.

In step 624, the user terminal 110 selects optimal content files it will use, based on the information recorded in the received metadata file. For example, the user terminal 110 determines an optimal bit rate at which it will play target content, based current network conditions and its performance.

To receive the selected content files, the user terminal 110 sets up an HTTP session to the home media server 130 based on the information recorded in the received metadata file in step 626 and the home media server 130 transmits the content files selected by the user terminal 110 based on the HTTP session in step 628.

Thereafter, user terminal 110 receives the content files transmitted from the home media server 130 and plays desired content using the received content files.

However, when the procedure of FIG. 6 is performed by the target terminal 150 instead of the home media server 130, the target terminal 150 may additionally perform steps 612 and 614. That is, upon receiving a request to provide target content data from the user terminal 110, the target terminal 150 provides a playback response to the user terminal 110 in response to request in step 612 and plays the target content requested by the user terminal 110 in step 614.

Step 614 may be performed before the request to provide target content data is received from the user terminal 110, i.e., the content may be generated and played by the target terminal 150 before the request to provide target content data is received from the user terminal 110.

It can be understood that the above-described embodiments of the present invention may be realized in the form of hardware, software, or a combination thereof The arbitrary software may be stored, for example, in volatile or non-volatile storage device such as Read Only Memory (ROM), or for example, in a memory such as Random Access Memory (RAM), memory chip, and Integrated Circuit (IC), or for example, in a storage medium that is optically or magnetically recordable and is readable by machine (e.g., computer), such as a Compact Disk (CD), Digital Versatile Disk (DVD), magnetic disk, and magnetic tape.

The content providing apparatus and method proposed by the present invention may be realized by a computer or a mobile terminal including a controller and a memory. It can be understood that the memory is a mere example of a storage medium, which is appropriate to store a program(s) including instructions for implementing embodiments of the present invention and is readable by machine Therefore, the present invention includes a program including codes for implementing the apparatus and/or method defined in certain claims of this specification, and a storage medium, which stores this program and is readable by machine (e.g., computer). This program may be electronically transferred through an arbitrary medium such as communication signals that are transmitted by wired/wireless connection, and the present invention may properly include equivalents thereto.

In addition, the content providing apparatus and method may receive the program from a program providing device connected thereto in a wired/wireless manner, and store the received program. The program providing device may include a program including instructions for allowing a graphic processing device to perform a preset content protection method, a memory for storing information for the content protection method, a communication unit for performing wired/wireless communication with the graphic processing device, and a controller for automatically transmitting a request or its associated program from the graphic processing device to a transmission/reception device.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for providing content stored in a home media server or other mobile terminal using a network condition-based adaptive data streaming service in a mobile terminal, the method comprising:
requesting, by the mobile terminal, the home media server or the other mobile terminal to provide target content data stored therein;
receiving a metadata file from a media management server that the home media server or the other mobile terminal can access; and
receiving content files that are generated by segmenting the target content data to support an optimal data streaming service in current network conditions, from one of the media management server, the home media server, and the other mobile terminal, based on information included in the metadata file.

2. The method of claim 1, wherein the target content data and access information for the mobile terminal are provided in advance to the media management server by the home media server or the other mobile terminal.

3. The method of claim 2, wherein receiving the content files from the media management server comprises:
determining a location at which the content files are stored, based on the information included in the metadata file;
setting up a Hypertext Transfer Protocol (HTTP) session to one of the media management server, the home media server, and the other mobile terminal, which corresponds to the determined location; and
receiving the content files based on the HTTP session.

4. The method of claim 3, wherein the information included in the metadata file includes information about a Uniform Resource Locator (URL) where the content files are stored.

5. An mobile terminal apparatus for providing content stored in a home media server or other mobile terminal using a network condition-based adaptive data streaming service, comprising:
a communication unit that requests the home media server or the other mobile terminal to provide target content data stored therein, receives a metadata file from a media management server that the home media server or the other mobile terminal can access, and receives content files from one of the media management server, the home media server, and the other mobile terminal;
a content player that plays the content files received via the communication unit; and
a controller that controls the communication unit to request the home media server or the other mobile terminal to provide the target content data, controls the communication unit to receive the content files from one of the media management server, the home media server, and the other mobile terminal, based on information included in the metadata file, and controls the content player to play the content files,
wherein the content files are generated by segmenting the target content data to support an optimal data streaming service in current network conditions.

6. The apparatus of claim 5, wherein the target content data and access information for the mobile terminal are provided in advance to the media management server by the home media server or the other mobile terminal.

7. The apparatus of claim 6, wherein the controller determines a location at which the content files are stored, based on the information included in the metadata file, sets up a Hypertext Transfer Protocol (HTTP) session to one of the media management server, the home media server and the other mobile terminal, which corresponds to the determined location, and controls the communication unit to receive the content files based on the HTTP session.

8. The apparatus of claim 7, wherein the information included in the metadata file comprises information about a Uniform Resource Locator (URL) where the content files are stored.

9. A method for providing content data to another mobile terminal using a network condition-based adaptive data streaming service by a home media server or a mobile terminal accessible to a media management server, the method comprising:
receiving, from the another mobile terminal, a request to provide target content data stored in the home media server or the mobile terminal; and
requesting the media management server to provide a metadata file corresponding to the target content data to the another mobile terminal; and
providing the target content data, information about target content, and access information for the another mobile terminal to the media management server.

10. The method of claim 9, further comprising:
generating content files by segmenting the target content data to enable transmission at a bit rate that supports an optimal data streaming service in current network conditions, without providing the target content data to the media management server; and
transmitting the content files to the another mobile terminal based on information included in the metadata file provided to the another mobile terminal by the media management server.

11. The method of claim 10, wherein transmitting the content files comprises:
setting up a Hypertext Transfer Protocol (HTTP) session to the another mobile terminal; and
transmitting the content files to the other mobile terminal based on the HTTP session.

12. An apparatus for providing content data to another mobile terminal using a network condition-based adaptive data streaming service in a home media server or a mobile terminal accessible to a media management server, comprising:
a memory for storing content data;
a communication unit that receives a request to provide target content data from the content data stored in the memory from the another mobile terminal, requests the media management server to provide a metadata file corresponding to the target content data to the another mobile terminal; and
a controller that controls the communication unit to request the media management server to provide the metadata file to the another mobile terminal, and to provide the target content data, information about target content, and access information for the another mobile terminal to the media management server.

13. The apparatus of claim 12, wherein the generates content files by segmenting the target content data to enable transmission at a bit rate that supports an optimal data streaming service in current network conditions, without providing the target content data to the media management server, and controls the communication unit to transmit the content files to the another mobile terminal based on information included in the metadata file provided to the another mobile terminal by the media management server.

14. The apparatus of claim 13, wherein the communication unit sets up a Hypertext Transfer Protocol (HTTP) session to the another mobile terminal, and transmits the content files to the another mobile terminal based on the HTTP session.

15. A method for supporting a content service for a mobile terminal based on network conditions by a media management server, the method comprising:
receiving a request to provide a metadata file to the mobile terminal from a home media server or other mobile terminal that can access the media management server;
generating the metadata file corresponding to target content data requested by the mobile terminal in content data stored in the home media server or the other mobile terminal, based on the target content data, information about the target content, and access information for the mobile terminal received from the home media server or the other mobile terminal; and
transmitting the generated metadata file to the mobile terminal.

16. The method of claim 15, further comprising:
generating content files by segmenting the target content data to enable transmission at a bit rate that supports an optimal data streaming service in current network conditions; and
transmitting the content files to the mobile terminal based on information recorded in the metadata file provided to the mobile terminal.

17. The method of claim 16, wherein transmitting the content files comprises:
setting up a Hypertext Transfer Protocol (HTTP) session to the mobile terminal; and
transmitting the content files to the mobile terminal based on the HTTP session.

18. A media management server apparatus that supports a content service for a mobile terminal based on network conditions, comprising:
a communication unit that receives a request to provide a metadata file to the mobile terminal from a home media server or other mobile terminal that can access the media management server, and transmits a metadata file to the mobile terminal; and
a metadata file generator that generates the metadata file corresponding to target content data requested by the mobile terminal from content data stored in the home media server or the other mobile terminal, based on the target content data, information about the target content, and access information for the mobile terminal received from the home media server or the other mobile terminal.

19. The apparatus of claim 18, further comprising a content file generator for generating content files by segmenting the target content data to enable transmission at a bit rate that supports an optimal data streaming service in current network conditions,
wherein the communication unit transmits the content files to the mobile terminal based on information recorded in the metadata file provided to the mobile terminal.

20. The apparatus of claim 19, wherein the communication unit sets up a Hypertext Transfer Protocol (HTTP) session to the mobile terminal, and transmits the content files to the mobile terminal based on the HTTP session.
